(19) United States
(12) Patent Application Publication
(10) Pub. No.: US 2019/0315597 A1
(43) Pub. Date: Oct. 17, 2019

(54) LIFTING SYSTEM WITH COUNTERWEIGHT PULLEYS AND CAGE ALIGNED ON THE SAME AXIS OF SYMMETRY

(71) Applicant: GMV Martini S.p. A., Pero (MI) (IT)

(72) Inventors: Angelo Martini, Pero (MI) (IT); David Donadello, Pero (MI) (IT)

(21) Appl. No.: 16/379,864

(22) Filed: Apr. 10, 2019

(30) Foreign Application Priority Data
Apr. 13, 2018 (IT) 102018000004466

(51) Int. Cl. B66B 9/00; B66B 11/02; B66B 17/12; B66B 15/02

(52) U.S. Cl. CPC B66B 9/00; B66B 15/02; B66B 17/12; B66B 11/02

(57) ABSTRACT

The invention relates to a lifting system for the transport of persons and for the movement of goods, with a traction unit (G) for a cage or goods hoist (10) provided with relative guides (18, 20), vertically movable inside a vertical run space (12) of a building between areas with a given height difference and provided with a bottom, side walls, a roof and mobile cage doors, in particular an electric wire rope elevator, with traction unit inside said vertical run space of the type called MRL (Machine Room Less), comprising a load supporting frame (14) and relative snub pulleys (28, 30), a moving counterweight (16) with relative guides (22, 24) and a snub pulley of the counterweight (32). In said system, said pulleys of the counterweight (16), of the traction unit (G) and of the frame (14) supporting the load contained in said cage, are aligned on the same axis, allowing the space useful for the movement of the cage to be optimised and thus making it possible to install a traction unit with greater lifting capacity.

The present invention relates to a lifting system with counterweight and cage pulleys aligned on the same axis of symmetry.

More particularly, the present invention relates to a lifting system as defined above, suitable for both the transport of persons and the movement of goods, comprising a cage or goods hoist, movable vertically inside a run space of a building between zones having a certain difference in height and provided with a bottom, side walls, a roof and mobile cage doors. Areas with a certain difference in height define the floors of the building; the run space in which the cage or hoist moves vertically is provided with openings at the various floors; the cage, in particular, has one or more entrances with manually or automatically opening cage doors while on the various floors of the building, at run space openings there are also floor doors. The cage moves along rigid guides, the inclination to the horizontal of which is greater than 15 degrees.

As is known, the movement of the cage is carried out by a motor unit, typically arranged at the upper end of the run space; hereinafter, reference will be made by way of example to electric wire rope elevators, with traction units inside the vertical run space, called MRL (Machine Room Less), which define the state of the art closest to the solution of the invention. Electric wire rope elevators are characterised by the fact that they are moved by a counterweight and include, as main components, a frame to support the load placed inside the mobile cage, traction cables, deflection or snub pulleys and a movement unit associated with said cage, which also controls its levelling at the floor. The most commonly used movement units are mainly of two types, i.e. geared winches or gearless winches; in the latter case, gearless winches are electrically actuated and have no mechanical transmission.

Reference will now be made only to lifts with gearless winches, which represent the scope of operation to which the solution of the present invention refers.

The known solutions of this type have a significant drawback, due to the fact that the space useful for the movement of the cage is not optimized. In fact, according to a known solution, the continuation of the axis of symmetry of the cage guides is external to the area which the counterweight pulleys look onto; this in the case of a conventional cable system with a special machine room, located above the upper end of the run space. In particular, the intersection of the centre line of the cage guides with that of the counterweight pulleys takes place only if said axes are extended with respect to the back of said guides. The traction unit supported by the support having one or more deflection pulleys rests on the floor of the machinery room and is positioned on the connection axis of the centres of symmetry of the respective counterweight and cage guides. Use inclination of the alignment with respect to the centreline axes of the guides imposes a rotation of the cables, which causes further inconvenience related to the wear of the traction means, imposing expensive replacement of the same; according to this solution the pulling of the system is direct, without the possibility of using snub pulleys to exploit the 2:1 suspension, which would allow a reduction of the power used by the traction unit.

In another case, the continuation of the axis of symmetry of the cage guides could be inside the area facing the counterweight guides, in the case of a cable system equipped with traction units located inside the upper end of the run space and supported directly by the counterweight guides and the single cage guide. In this case, the axis of symmetry of the cage guides is perpendicular and internal to the axis facing the counterweight guides, but this requires a 90° rotation of the traction cables in the passage from the traction pulley to the mobile counterweight deflection pulley. Consequently, this rotation of the traction means causes wear and tear of the same and makes costly replacements necessary; moreover, this known solution limits the number of cables that can be used.

In addition, the maximum permissible inclination of the cables with respect to the traction pulley grooves must be lower than 4° according to the regulations; this limit imposes distances and dimensions that do not allow a reduction in height of the upper end of the run space. For all these reasons an increase of the upper end of the run space is mandatory with relative costs.

WO 2004/106206 relates to a lift driven vertically by guide rails arranged diagonally. In particular, this solution relates to cage guides that are on separate axes, wherein the third guide serves only to prevent rotation and is not used to guide said cage. In the patent GB 2 395 191 the elevator machine and the counterweight are suspended on the lifting cables by a deflection pulley; the cage guides are not however considered.

In EP 1 616 833 a lift with cage intended for persons and goods includes flat and parallel load bearing belts as a connection between said cage and a counterweight; the belts are aligned on parallel vertical planes and the main guides are arranged diagonally. JP 2002 173279 also discloses the solution of making a lift in which the lateral guides are positioned on the internal surfaces of the axis of the lift itself to reduce the dimensions, with the lateral pulleys of the cage arranged diagonally.

The purpose of the present invention is to overcome the aforesaid drawbacks.

More particularly, the purpose of the present invention is to provide a lifting system, for MRL lifts with traction units inside the run space in which the arrangement of the cage guides and the counterweight allows the space useful for the movement of the cage to be optimised.

A further and consequent purpose of the invention is to provide a lifting system as defined above in which the optimization of the space useful for the movement of the cage makes it advantageously possible to install a traction unit with greater lifting capacity than the conventional solutions.

A no less important purpose of the invention to provide a lifting system capable of preventing the rotation of the traction cables, thereby reducing their wear.

A further purpose of the invention is to make available to users a lifting system suitable to ensure a high level of resistance and reliability over time, in addition such as to be easily and economically made.

These and other purposes are achieved by the lifting system of the present invention according to the main claim.

The construction and functional characteristics of the lifting system of the present invention will be more clearly comprehensible from the detailed description below in which reference is made to the appended drawings which show a preferred and non-limiting embodiment and wherein:

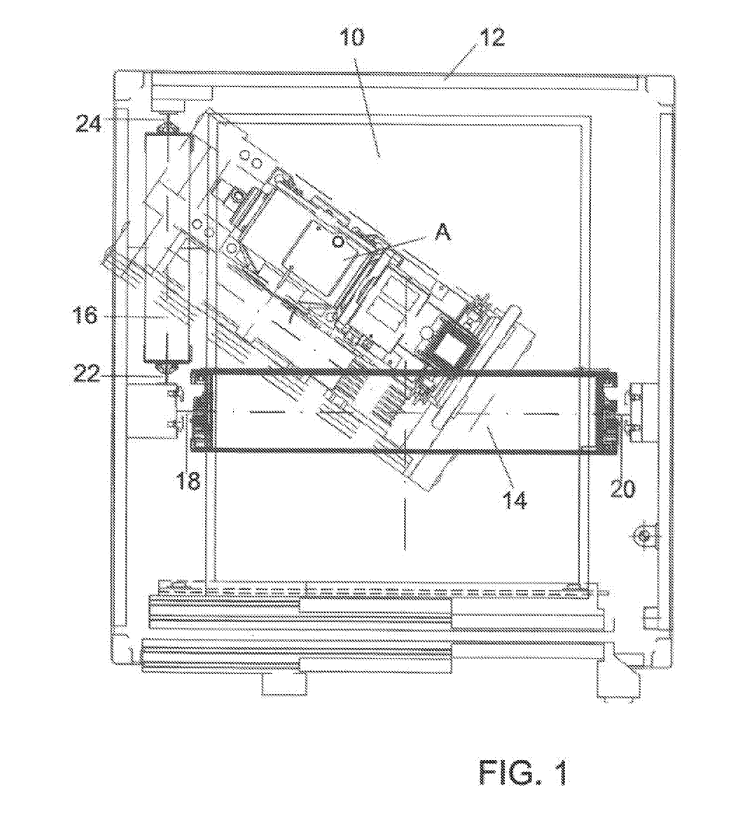

FIGS. 1, 2 and 3 show schematically in as many plan views the configuration of a cable lifting system of the known type, respectively provided in the first case with the appropriate machinery space located above the upper end of the run space and without, in the second case, such a special machinery space, but with the traction unit inside the upper end of the run space;

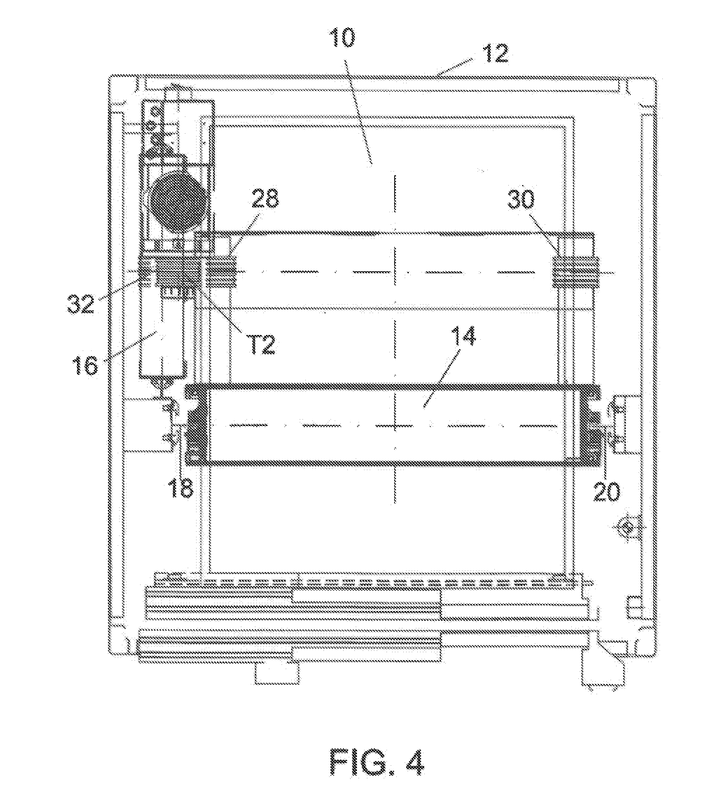

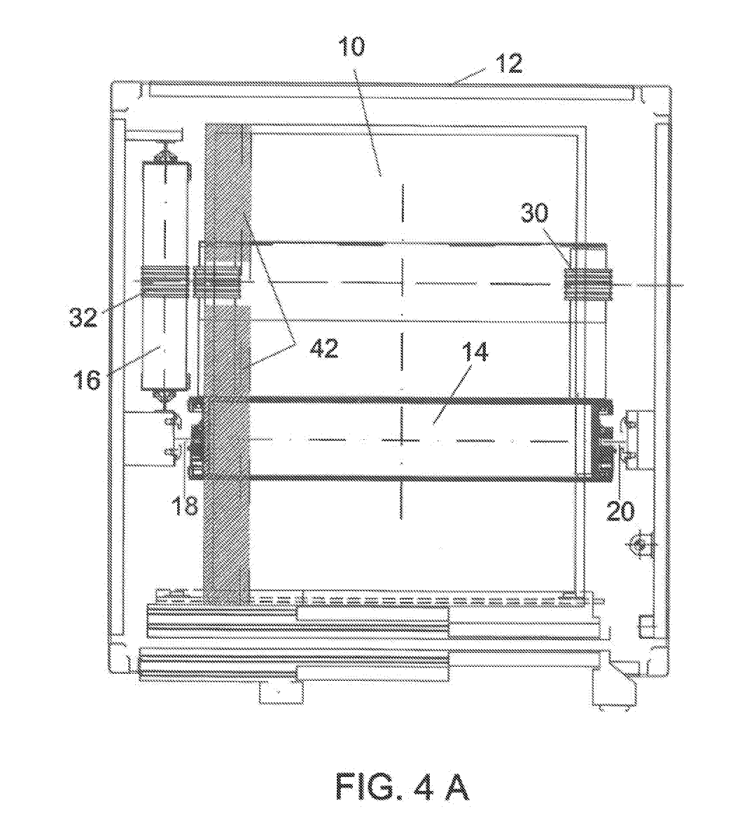

FIG. 4 schematically shows the plan configuration of a cable lifting system in accordance with the present invention, wherein the traction unit is positioned inside the upper end of the run space;

FIG. 4A schematically shows the plan configuration of the same cable lifting system in accordance with the present invention to highlight the increase obtainable as regards the extension of the surface of the cage floor compared to conventional solutions;

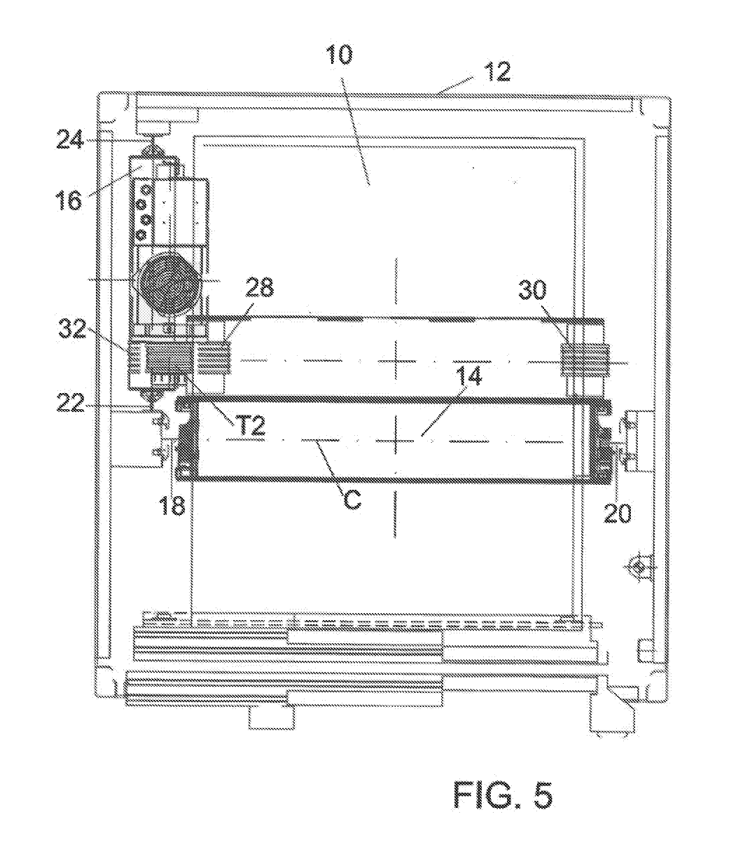

FIG. 5 schematically shows a view analogous to the above, with the snub pulleys positioned according to the arrangement of the invention;

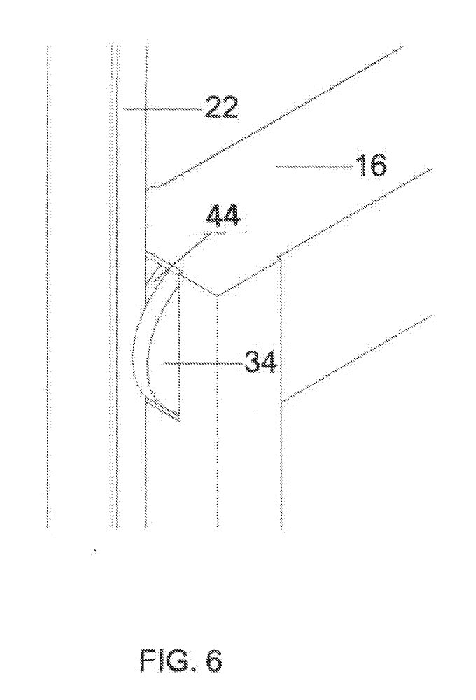

FIG. 6 schematically shows, from a perspective view, the counterweight constraint kinematics to the respective guides according to the invention;

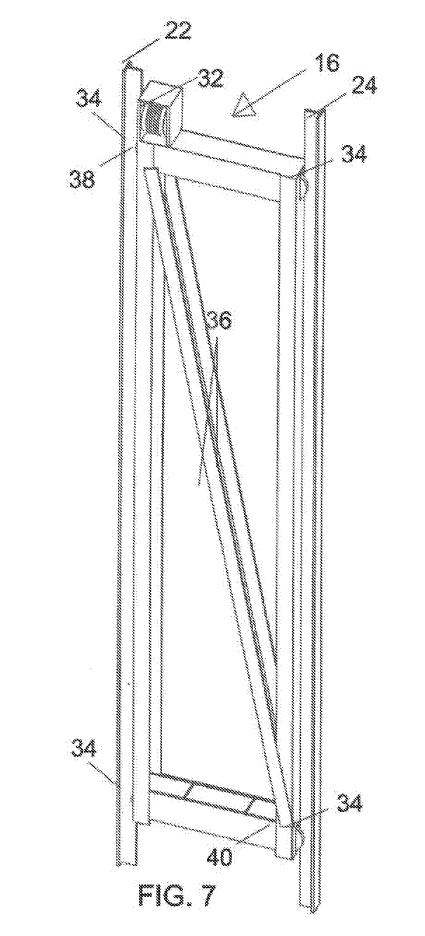

FIG. 7 schematically shows a perspective view of the counterweight according to the invention, wherein the snub pulley is decentralized with respect to the axes of symmetry.

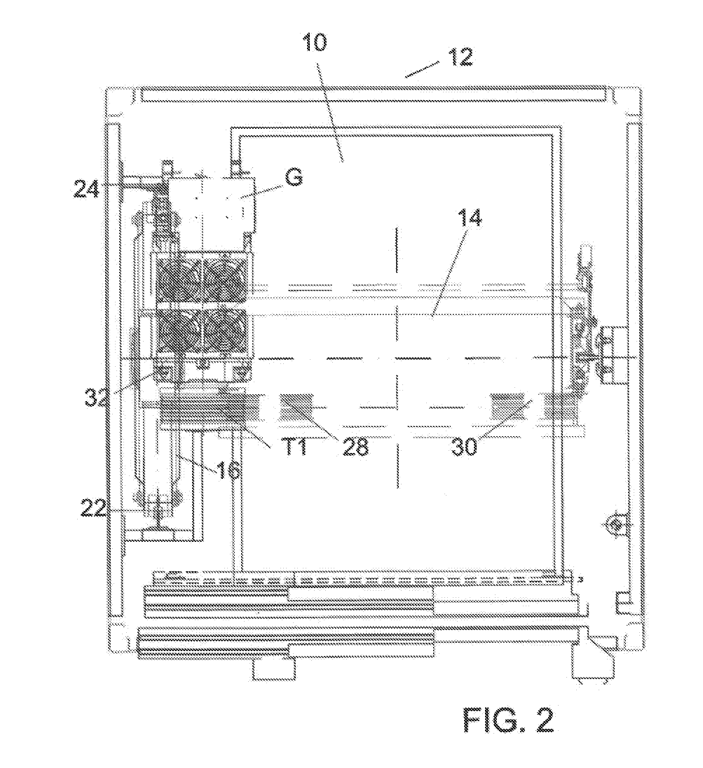

With reference to the aforesaid figures, the lifting system according to the present invention comprises a traction unit (G) for a cage or goods hoist 10 that is moved in a run space 12, as shown in FIG. 2, on which the load support frame and the movement counterweight are indicated, respectively, as 14 and 16; in FIG. 1 a traditional winch is further schematically shown as A.

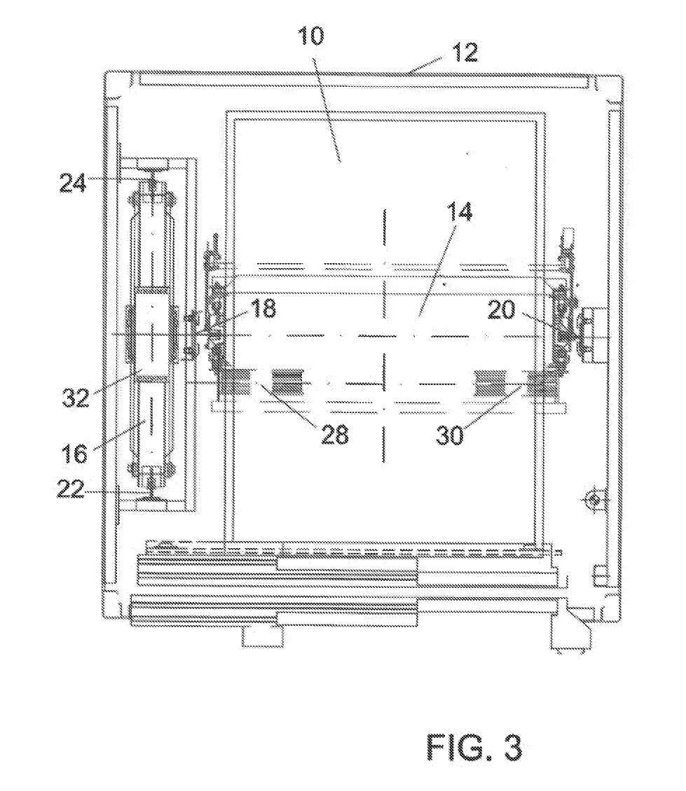

FIG. 3, on the other hand, schematically illustrates a known arrangement of the axis of symmetry of the cage guides 18 and 20, the continuation of which is inside the area which the counterweight guides, indicated as 22 and 24, face onto in the case of a cable system having the traction unit, supported directly by said guides of the counterweight and the single guide (18) of the cage inside the upper end of the run space. In this case, the axis of symmetry of the cage guides 18 and 20 is perpendicular and internal to the facing axis of the counterweight guides 22 and 24, thus imposing a 90° rotation of the traction cables (not illustrated) in the passage from the traction pulley (T1) (FIG. 2) to the movable 32 deflection pulley of the counterweight 16, with the drawbacks stated above.

According to the invention, with particular reference to FIG. 4, the traction pulley now indicated as T2 is aligned on the same axis of symmetry as both the counterweight 16 and the lifting kinematics or snub pulleys indicated as 28, 30, installed for the movement of the frame 14 supporting the load. According to this configuration illustrated in FIG. 4, the arrangement of the cage pulleys defined by the lifting kinematics or snub pulleys 28, 30 optimizes the useful space for the movement of the load support, allowing an increase in the surface area of the floor of the cage 10 compared to that obtained with the solutions of the prior art; the area defining such an increase in the surface area of the floor of the cage 10 is shown as a dashed line 42 in FIG. 4A. Furthermore, the cage guide 18 in FIG. 3, interposed between the cage 10 and the counterweight 16 in conventional solutions, is not seen in the solution of the present invention, which allows said spaces to be optimized. In the lifting system of the present invention, the lifting kinematics or snub pulleys 28, 30, 32 illustrated in FIGS. 4 and 5 have a reduced diameter, equal to 120 mm compared to the usual 240 mm. The snub pulley 32 is rotated by 90° with respect to traditional solutions, such as that shown schematically in FIG. 3; this rotation allows the alignment of the traction pulley T2 and the lifting kinematics or snub pulleys 28 and 30, 32 on the same axis of symmetry, as can be seen in FIGS. 4 and 5.

It should be further considered that the decentralization of the counterweight snub kinematics 32, as shown schematically in FIG. 5, limits the distance between the lifting kinematics defined by the snub pulleys 28, 30, installed for the movement of the support frame 14 supporting the load, and the axis of symmetry of the cage guides indicated as C in FIG. 5, reducing the stresses and resistant moments generated during the suspension and movement of the load. An incision, indicated as 44 in FIG. 6, defines a channel on the roller surface of the restraint kinematisms 34 and allows the correct alignment of the counterweight 16 during the movement of the frame relative to the axis of the guides 22 and 24 of said counterweight, preventing dangerous derailing. Said kinematics then make rotation possible thereby avoiding wedging of the counterweight 16 during its stroke, while the structural strength of the frame of said counterweight frame is guaranteed by appropriate constraints 36, shown schematically in FIG. 7, which connect the vertices 38 and 40 of said counterweight 16.

As may be seen from the above, the advantages which the invention achieves are significant.

The lifting system of the present invention allows a reduction of the dimensions of the mechanical component and, consequently, a significant increase in the space useful for the movement of the cage advantageously possible.

Despite the invention having been described above with particular reference to one of its embodiments, given solely by way of a non-limiting example, numerous modifications and variants will appear evident to a person skilled in the art in the light of the above description. The present invention therefore sets out to embrace all the modifications and variants which fall within the sphere and scope of the following claims.

1. A lifting system for the transport of persons and for the movement of goods, with a traction unit (G) and traction pulley (T2) for a cage or goods hoist (10) provided with relative guides (18, 20), vertically movable inside a vertical run space (12) of a building between areas with a given height difference and provided with a bottom, side walls, a roof and mobile cage doors, in particular an electric wire rope elevator, with traction unit inside said vertical run space of the type called MRL (Machine Room Less), comprising a load supporting frame (14) and relative snub pulleys (28, 30), a moving counterweight (16) with relative guides (22, 24) and a snub pulley of the counterweight (32), characterized in that said counterweight (16), traction (T2) and frame (14) pulleys supporting the load contained in said cage are aligned on the same axis.

2. The lifting system according to claim 1, characterized in that the axis of symmetry of the cage guides (18, 20) is outside the area which the guides (22, 24) of the counterweight (16) look onto.

3. The lifting system according to claim 1, characterized in that the axis of the pulley (32) of the counterweight (16) is decentralized relative to the centreline axis which the relative guides (22, 24) look onto.

4. The lifting system according to claim 1, characterized in that the counterweight (16) comprises constraints (34) made with kinematics fixed at the vertices (38, 40) of said counterweight.

5. The lifting system according to the preceding claims, characterized in that the arrangement of the snub kinematic mechanisms or snub pulleys (28, 30, 32) results in an increase in the movement spaces of the load support, with a greater surface area (42) of the cage floor (10).

6. The lifting system according to claim 4, characterized in that it comprises an incision (44) that defines a channel on the surface of the restraints roller (34) and allows the correct alignment of the counterweight (16) during the movement of the frame relative to the axis of the guides (22, 24) of said counterweight.

7. The lifting system according to claim 5, characterized in that the lifting kinematism or the snub pulleys (28, 30, 32) have a diameter of 120 mm.
